(19) United States
(12) Patent Application Publication
(10) Pub. No.: US 2025/0111647 A1
(43) Pub. Date: Apr. 3, 2025

(54) PALLET RECOGNITION DEVICE

(71) Applicant: KABUSHIKI KAISHA TOYOTA JIDOSHOKKI, Kariya-shi (JP)

(72) Inventor: Masahiro KISHIDA, Kariya-shi (JP)

(73) Assignee: KABUSHIKI KAISHA TOYOTA JIDOSHOKKI, Kariya-shi (JP)

(21) Appl. No.: 18/893,372

(22) Filed: Sep. 23, 2024

(30) Foreign Application Priority Data
Sep. 29, 2023 (JP) 2023-169601

(51) Int. Cl. G06V 10/75; B66F 9/075; G06V 10/771

(52) U.S. Cl. CPC G06V 10/75; G06V 10/771; B66F 9/0755; G06V 2201/06

(57) ABSTRACT

A pallet recognition device that recognizes a position and a state of a pallet includes a memory configured to store pieces of reference data acquired in advance, the pieces of reference data corresponding to a plurality of types of pallets, a detection unit configured to determine a type of the pallet, a selection unit configured to select reference data corresponding to the type of the pallet detected by the detection unit from the pieces of reference data of the plurality of types of pallets stored in the memory, a data acquisition unit configured to acquire detection data of the pallet, and a matching processor configured to calculate estimation values of a position and a state of the pallet by matching the detection data acquired by the data acquisition unit and the reference data selected by the selection unit.

### CROSS-REFERENCE TO RELATED APPLICATION

This application claims priority to Japanese Patent Application No. 2023-169601 filed on Sep. 29, 2023, the entire disclosure of which is incorporated herein by reference.

### BACKGROUND ART

The present disclosure relates to a pallet recognition device.

As a conventional pallet recognition device, a technique disclosed in Japanese Patent Application Publication No. 2021-042070 has been known. The pallet recognition device of the above Publication includes a laser sensor that detects a distance to a pallet corresponding to a cargo handling target, a camera that captures an image of the pallet corresponding to the cargo handling target, and a controller that calculates a plane equation for a front surface of the pallet based on image data from the camera and measurement point data from the laser sensor, and estimates a position and a state of the pallet using the plane equation.

In cargo handling operations, a flat pallet as described in the above Publication, a post pallet that can be stacked with a cargo placed thereon, and the like are used as a pallet. Depending on how the cargo is loaded onto the pallet and where the pallet is placed, detection of the front surface of the pallet becomes difficult. As a result, estimation of a position and a state of the pallet may become difficult.

The present disclosure is directed to providing a pallet recognition device that can improve the accuracy in estimation of the position and the state of a pallet, regardless of the type of a pallet.

### SUMMARY

In accordance with an aspect of the present disclosure, there is provided a pallet recognition device that recognizes a position and a state of a pallet includes a memory configured to store pieces of reference data acquired in advance, the pieces of reference data corresponding to a plurality of types of pallets, a detection unit configured to determine a type of the pallet, a selection unit configured to select reference data corresponding to the type of the pallet detected by the detection unit from the pieces of reference data of the plurality of types of pallets stored in the memory, a data acquisition unit configured to acquire detection data of the pallet, and a matching processor configured to calculate estimation values of a position and a state of the pallet by matching the detection data acquired by the data acquisition unit and the reference data selected by the selection unit.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a schematic configuration diagram illustrating a travelling control device that includes a pallet recognition device according to an embodiment of the present disclosure;

FIG. 2 is a schematic plan view illustrating a pallet being unloaded by a forklift truck;

FIGS. 3A and 3B are front views illustrating, as the pallet, a flat pallet, and a post pallet, respectively;

FIG. 4 is a flowchart of a pallet recognition and travel control process executed by a controller illustrated in FIG. 1;

FIGS. 5A, 5B, and 5C are views in which detection point cloud data acquired by a laser sensor is matched with selected reference point cloud data;

FIGS. 6A and 6B are views in which a flat pallet is placed on a conveyor provided with a guard for preventing the pallet from falling off; and

FIGS. 7A and 7B are views in which opposite edges of a cargo are erroneously detected as posts of the post pallet when the cargo placed on a pallet portion of the post pallet protrudes from a front surface of the post pallet.

### DETAILED DESCRIPTION OF THE EMBODIMENTS

The following will describe an embodiment of the present disclosure in detail with reference to the accompanying drawings.

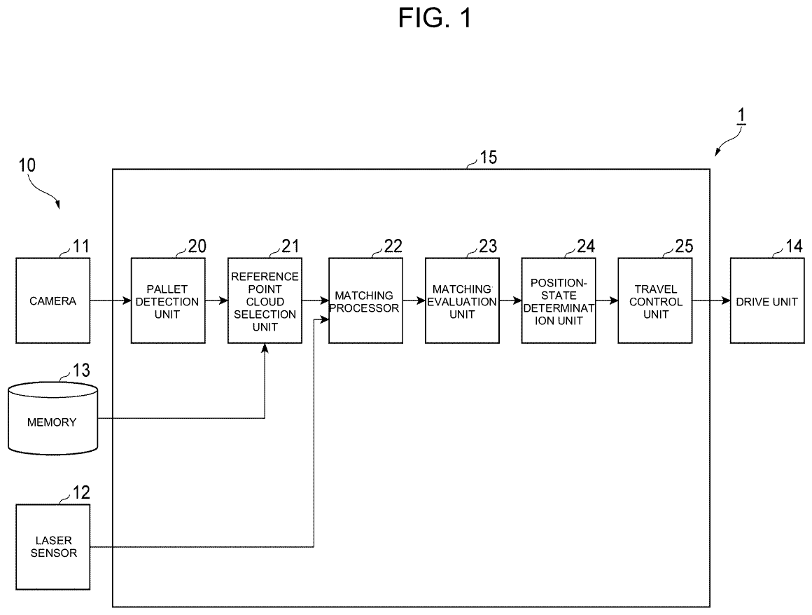

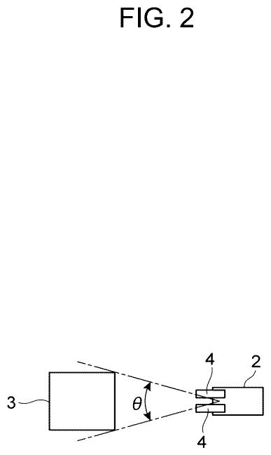

FIG. 1 is a schematic configuration diagram illustrating a travelling control device that includes a pallet recognition device according to an embodiment of the present disclosure. A travelling control device 1 is a device that causes a forklift truck 2 to travel automatedly to an unloading position when the forklift truck 2 unloads a pallet 3, as illustrated in FIG. 2. The forklift truck 2 has a pair of left and right forks 4 for holding the pallet 3. The unloading position is a position where the forks 4 of the forklift truck 2 are inserted into fork holes, which will be described later, of the pallet 3.

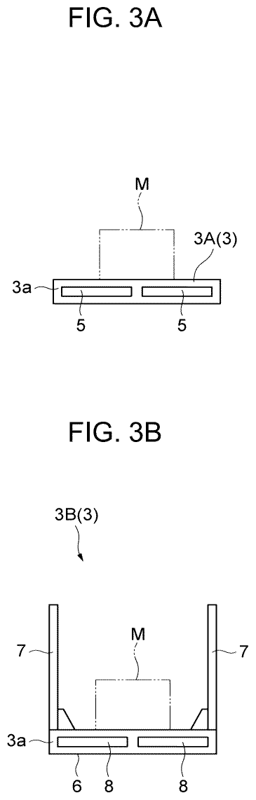

The pallet 3 is loaded, for example, on a platform of a truck (not illustrated). As the pallet 3, a flat pallet 3A and a post pallet 3B as illustrated in FIGS. 3A and 3B are used.

The flat pallet 3A in FIG. 3A is a plastic flat pallet or a wooden flat pallet, for example. The flat pallet 3A has a substantially square shape in plan view. A cargo M is placed on the flat pallet 3A. The flat pallet 3A has two fork holes 5 into which the forks 4 of the forklift truck 2 are inserted. The fork holes 5 extend rearwardly from the front surface 3a of the flat pallet 3A. The fork holes 5 each have a rectangular shape in front view.

The post pallet 3B illustrated in FIG. 3B has a pallet portion 6 having a square shape in plan view, and four posts 7 standing from four corners of the pallet portion 6. The cargo M is placed on the pallet portion 6. The pallet portion 6 has two fork holes 8 into which the forks 4 of the forklift truck 2 are inserted. The fork holes 8 extend rearwardly from the front surface 3a of the post pallet 3B. The fork holes 8 each have a rectangular shape in front view. The posts 7 each have a quadrangular pillar shape. The posts 7 are connected to the corners of the pallet portion 6, respectively, so as to be foldable.

In FIG. 1, the travelling control device 1 is mounted on the forklift truck 2. The travelling control device 1 includes a camera 11, a laser sensor 12, a memory 13, a drive unit 14, and a controller 15.

The camera 11 captures an image of the front surface 3a of the pallet 3 to be unloaded to obtain image data. For example, a monocular camera is used as the camera 11.

The laser sensor 12 detects a distance to the pallet 3 to be unloaded by irradiating the front surface 3a of the pallet 3 with a laser and receiving reflection light of the laser to obtain point cloud data. Point cloud is a set of laser reflection points in objects including the pallet 3. The laser sensor 12 serves as a data acquisition unit that acquires detection point cloud data (detection data) of the pallet 3. The laser sensor 12 emits a 2D or 3D laser with high point density. For example, a LIDAR or a laser range finder is used as the laser sensor 12.

The memory 13 stores pieces of reference point cloud data (reference data) of the front surfaces 3a of a plurality of types of pallets 3. The pieces of the reference point cloud data are acquired in advance using the laser sensor 12. The pieces of the reference point cloud data are data corresponding to the plurality of types of pallets 3 acquired in advance. Herein, as the plurality of types of pallets 3, not only different types of the pallets 3, but also the pallets 3 having the same type and different appearances are included. For example, appearance of one of the pallets 3 of the same type may be different from the others in a case where a part of the pallet 3 is covered by another object due to a change in how the cargo M is placed or where the pallet 3 is located.

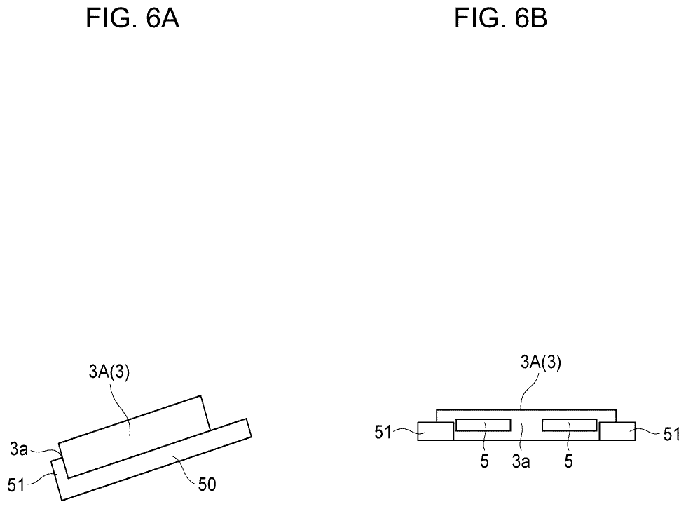

Specifically, the pieces of the reference point cloud data of the front surfaces 3a of the plurality of types of the pallets 3 include reference point cloud data of the front surface 3a of the flat pallet 3A (see FIG. 3A) and reference point cloud data of the front surface 3a of the post pallet 3B (see FIG. 3B). In addition, the pieces of the reference point cloud data of the front surfaces 3a of the plurality of types of the pallets 3 also include reference point cloud data of the front surface 3a of the flat pallet 3A in a state in which the front surface 3a is partially covered by another object (see FIG. 6B).

The drive unit 14 includes a travel motor (not illustrated) that rotates the drive wheels of the forklift truck 2 and the steering motor (not illustrated) that steers a steering wheel of the forklift truck 2, for example.

The controller 15 includes a CPU, a RAM, a ROM, and input/output interfaces. The controller 15 has a pallet detection unit 20, a reference point cloud selection unit 21 (selection unit), a matching processor 22, a matching evaluation unit 23 (evaluation unit), a position-state determination unit 24, and a travel control unit 25.

The pallet detection unit 20, the reference point cloud selection unit 21, the matching processor 22, the matching evaluation unit 23, and the position-state determination unit 24 cooperate with the camera 11, the laser sensor 12 and the memory 13 to form the pallet recognition device 10 of the present embodiment. The pallet recognition device 10 is a device that recognizes a position and a state of the pallet 3.

The pallet detection unit 20 detects the type of the pallet 3 based on the image data from the camera 11. The pallet detection unit 20 and the camera 11 cooperate to form a determination unit that detects the type of the pallet 3.

The reference point cloud selection unit 21 selects reference point cloud data corresponding to the type of the pallet 3 detected by the pallet detection unit 20 from pieces of the reference point cloud data of the plurality of types of the pallets 3 stored in the memory 13.

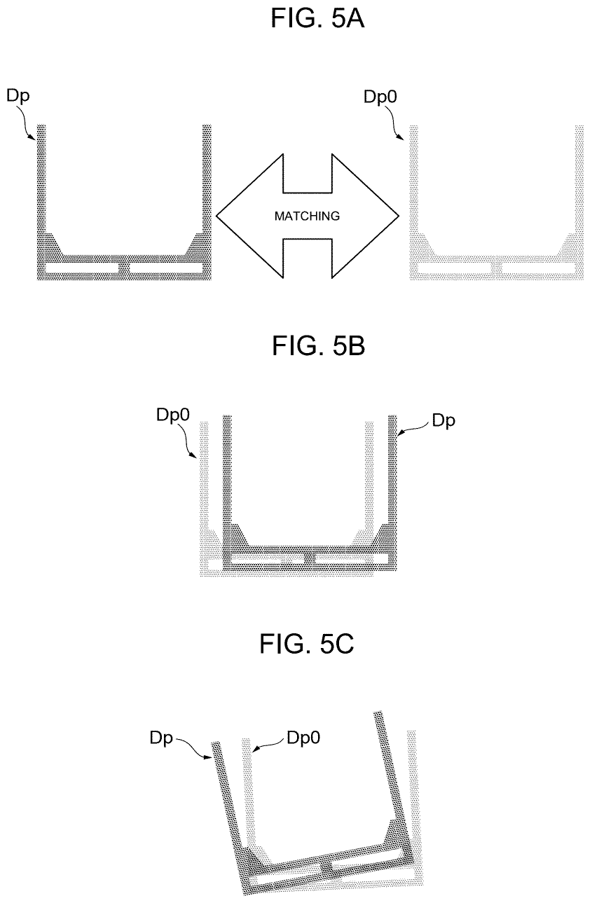

The matching processor 22 calculates estimation values of the position and the state of the pallet 3 by matching the detection point cloud data of the pallet 3 acquired by the laser sensor 12 with the reference point cloud data selected by the reference point cloud selection unit 21 (see FIGS. 5A, 5B, 5C), and calculates the degree of matching between the detection point cloud data and the reference point cloud data. The functions of the matching processor 22 will be described in detail later.

The matching evaluation unit 23 evaluates the estimation values of the position and the state of the pallet 3 calculated by the matching processor 22. The matching evaluation unit 23 evaluates the estimation values of the position and the state of the pallet 3 by determining whether or not the degree of matching between the detection point cloud data of the pallet 3 and the reference point cloud data is equal to or greater than a threshold determined in advance.

The position-state determination unit 24 determines the position and the state of the pallet 3 according to a result of the evaluation by the matching evaluation unit 23.

When the matching evaluation unit 23 determines that the degree of matching between the detection point cloud data and the reference point cloud data is equal to or greater than the threshold, the position-state determination unit 24 determines the estimation values of the position and the state of the pallet 3 calculated by the matching processor 22 as the position and the state of the pallet 3. When the matching evaluation unit 23 determines that the degree of matching between the detection point cloud data and the reference point cloud data is less than the threshold, the position-state determination unit 24 estimates the position and the state of the pallet 3 based on the detection point cloud data of the pallet 3 acquired by the laser sensor 12.

When it is determined that the degree of matching between the detection point cloud data and the reference point cloud data is less than the threshold, the position-state determination unit 24 extracts pieces of the detection point cloud data of the pallet 3 acquired by the laser sensor 12, which match the reference point cloud data, and estimates the position and the state of the pallet 3 based on the pieces of the detection point cloud data, which match the reference point cloud data.

The travel control unit 25 controls the drive unit 14 such that the forklift truck 2 travels to the unloading position based on the position and the state of the pallet 3 determined by the position-state determination unit 24.

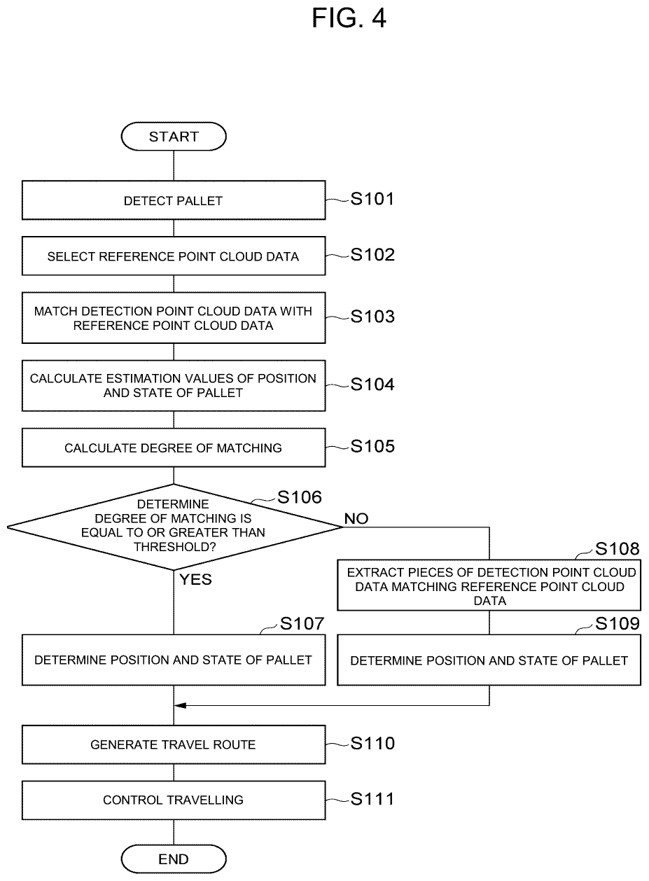

FIG. 4 is a flowchart of a pallet recognition and travel control process executed by the controller 15. This process is executed when start of unloading is instructed in a state in which the forklift truck 2 reaches the front surface 3a of the pallet 3 to be unloaded, as illustrated in FIG. 2. It is noted that an angle θ in FIG. 2 represents a detection range where the pallet 3 is detected.

In FIG. 4, firstly, the controller 15 detects a type, the number, and an approximate location of the pallets 3 to be unloaded based on image data from the camera 11 (step S101). At this time, the controller 15 detects the type, the number, and the approximate location of the pallets 3 based on machine learning such as deep learning.

Next, the controller 15 selects the reference point cloud data corresponding to the type of the pallets 3 detected in step S101 from the pieces of the reference point cloud data of the plurality of types of the pallets 3 stored in the memory 13 (step S102). When it is detected that the type of pallets 3 is the flat pallet 3A (see FIG. 3A), the reference point cloud data corresponding to the flat pallet 3A is selected. When it is detected that the type of pallets 3 is the post pallet 3B (see FIG. 3B), the reference point cloud data corresponding to the post pallet 3B is selected.

Subsequently, as illustrated in FIG. 5A, the controller 15 matches the detection point cloud data of the pallet 3 acquired by the laser sensor 12 with the reference point cloud data selected in step S102 (step S103). In FIG. 5A, detection point cloud data Dp acquired at the time of irradiating the post pallet 3B with a laser is matched with reference point cloud data Dp0 corresponding to the post pallet 3B. For example, ICP (iterative closest point) matching is used as a matching method.

Then, the controller 15 calculates the estimation values of the position and the state of the pallet 3 to be unloaded from a result of matching between the detection point cloud data and the reference point cloud data (step S104). At this time, the controller 15 performs estimation calculation of the position and the state of the pallet 3 by translating the detection point cloud data Dp relative to the reference point cloud data Dp0 as illustrated in FIG. 5B and by rotating the detection point cloud data Dp relative to the reference point cloud data Dp0 as illustrated in FIG. 5C. It is noted that, for the sake of description, an amount of variation between the detection point cloud data Dp and the reference point cloud data Dp0 is illustrated to be greater than it actually is in FIG. 5B and FIG. 5C.

In addition, the controller 15 calculates the degree of matching between the detection point cloud data and the reference point cloud data from the result of matching between the detection point cloud data and the reference point cloud data (step S105). The calculation of the degree of matching is performed as evaluation of the estimation values of the position and the state of the pallet 3 calculated in step S104.

Next, the controller 15 determines whether or not the degree of matching between the detection point cloud data and the reference point cloud data is equal to or greater than the threshold determined in advance (step S106). The degree of matching is expressed, for example, as a percentage (%).

When the controller 15 determines that the degree of matching between the detection point cloud data and the reference point cloud data is equal to or greater than the threshold, the controller 15 determines the estimation values of the position and the state of the pallet 3 calculated in step S104 as the position and the state of the pallet 3 to be unloaded (step S107).

When the controller 15 determines that the degree of matching between the detection point cloud data and the reference point cloud data is less than the threshold, the controller 15 extracts pieces of the detection point cloud data acquired by the laser sensor 12, which matches the reference point cloud data selected in step S102 (step S108). Then, the controller 15 estimates the position and the state of the pallet 3 to be unloaded based on the pieces of the detection point cloud data extracted in step S108 (step S109).

Specifically, when the pallet 3 is the flat pallet 3A as illustrated in FIG. 3A, the controller 15 extracts, for example, the two fork holes 5 of the flat pallet 3A based on the detection point cloud data, and estimates the position and the state of the flat pallet 3A from the positional relationship between the two fork holes 5.

When the pallet 3 is the post pallet 3B as illustrated in FIG. 3B, the controller 15 extracts, for example, a horizontal line corresponding to the pallet portion 6 and vertical lines corresponding to the posts 7 based on the detection point cloud data, and calculates the position and the state of the post pallet 3B from the positional relationship between the horizontal line and the vertical lines.

In addition, the controller 15 determines that the estimation of the position and the state of the pallet 3 is unsuccessful depending on the variation in the detection point cloud data matching the reference point cloud data using characteristics that the variation in the detection point cloud data matching the reference point cloud data increases when matching between the detection point cloud data and the reference point cloud data is unsuccessful.

After executing step S107 or step S109, the controller 15 generates a travel route from the forklift truck 2 to the unloading position based on the position and the state of the pallet 3 to be unloaded (step S110). Then, the controller 15 controls the drive unit 14 such that the forklift truck 2 travels along the travel route to the unloading position (step S111).

The pallet detection unit 20 executes step S101. The reference point cloud selection unit 21 executes step S102. The matching processor 22 executes steps S103 to S105. The matching evaluation unit 23 executes step S106. The position-state determination unit 24 executes steps S107 to S109. The travel control unit 25 executes steps S110 and S111.

In some cases, fall prevention guards 51 are provided on both the left and right sides of the tip of a conveyor 50 to prevent the flat pallet 3A placed on the inclined conveyor 50 from falling off, as illustrated in FIG. 6A. In this case, the front surface 3a of the flat pallet 3A is partially covered by the guards 51 as illustrated in FIG. 6B. As a result, the front surface 3a of the flat pallet 3A is not detected accurately when the detection point cloud data is acquired by the laser sensor 12, so that accuracy in estimation of the position and the state of the flat pallet 3A decreases. For the sake of convenience, the conveyor 50 is not illustrated in FIG. 6B.

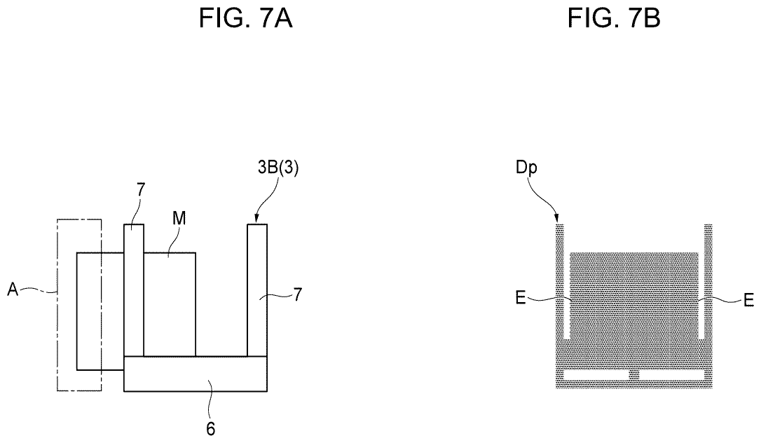

Furthermore, as illustrated in FIG. 7A, when a large cargo M placed on the pallet portion 6 of the post pallet 3B protrudes from the front surface 3a of the post pallet 3B (see A in the illustration), the cargo M is positioned closer to the laser sensor 12 than the post pallet 3B. Thus, as illustrated in FIG. 7B, when the detection point cloud data Dp is acquired by the laser sensor 12, side edges E of the cargo M may be erroneously detected as the posts 7 of the post pallet 3B. In this case, the accuracy in estimation of the position and the state of the post pallet 3B decreases.

To address such a problem, in the present embodiment, the reference point cloud data for a plurality of types of pallets 3 is acquired in advance and stored in the memory 13. In recognizing the pallet 3, the type of the pallet 3 is identified using the camera 11. Then, from pieces of the reference point cloud data of the plurality of types of pallets 3 stored in the memory 13, the reference point cloud data corresponding to the type of the pallet 3 having been identified is selected.

For example, when the pallet 3 is the flat pallet 3A and the flat pallet 3A is placed on the platform of a normal truck (see FIG. 3A), the reference point cloud data of the front surface 3a of the flat pallet 3A is selected. When the pallet 3 is the flat pallet 3A and the flat pallet 3A is placed on the conveyor 50 equipped with the guards 51 to prevent the pallet 3A from falling off (see FIGS. 6A and 6B), the reference point cloud data for the front surface 3a of the flat pallet 3A including the two guards 51 is selected. When the pallet 3 is the post pallet 3B (see FIGS. 3B and 7A), the reference point cloud data of the front surface 3a of the post pallet 3B is selected.

Then, the detection point cloud data of the pallet 3 acquired by the laser sensor 12 is matched with the selected reference point cloud data to calculate the estimation values of the position and the state of the pallet 3. By matching the detection point cloud data of the pallet 3 with the reference point cloud data corresponding to the type of the pallet 3 in this manner, the pallet recognition device 10 becomes more resistant to external disturbances, and erroneous estimation of the position and the state of the pallet 3 is less likely to occur even if the type of the pallet 3 used is changed. This improves the accuracy in estimation of the position and the state of the pallet 3 regardless of the types of the pallets 3. As a result, the forklift truck 2 can be moved to the unloading position with high accuracy.

In the present embodiment, the estimation values of the position and the state of the pallet 3 acquired by matching the detection point cloud data acquired by the laser sensor 12 with the selected reference point cloud data are evaluated, and the position and the state of the pallet 3 are determined based on the result of evaluation. As a result, the accuracy in estimation of the position and the state of the pallet 3 is further improved.

In the present embodiment, the degree of matching between the detection point cloud data acquired by the laser sensor 12 and the selected reference point cloud data is calculated, and whether the degree of matching between the detection point cloud data and the reference point cloud data is equal to or greater than a threshold value is determined. As a result, the estimation values of the position and the state of the pallet 3 can be evaluated easily and accurately.

In the present embodiment, when the degree of matching between the detection point cloud data acquired by the laser sensor 12 and the selected reference point cloud data is equal to or greater than the threshold, the estimation values of the position and the state of the pallet 3 acquired by matching the detection point cloud data with the reference point cloud data are determined as the position and the state of the pallet 3. As a result, the accuracy in estimation of the position and the state of the pallet 3 is more reliably improved.

In the present embodiment, when the degree of matching between the detection point cloud data acquired by the laser sensor 12 and the selected reference point cloud data is less than the threshold, the pieces of the detection point cloud data that match the reference point cloud data are extracted from the detection point cloud data, and the position and the state of the pallet 3 are estimated based on the pieces of the detection point cloud data that match the reference point cloud data. As a result, whether the matching between the detection point cloud data and the reference point cloud data has been actually unsuccessful can be checked.

In the present embodiment, the type of the pallet 3 can be identified easily and inexpensively by using the camera 11 that captures an image of the pallet 3. Furthermore, the detection point cloud data and the reference point cloud data can be easily matched by irradiating the pallet 3 with a laser to acquire the detection point cloud data.

In the present embodiment, the reference point cloud data for a state in which the pallet 3 is partially covered by the guards 51 is stored in the memory 13 in advance. As a result, the accuracy in estimation of the position and the state of the pallet 3 is improved even when the pallet 3 is partially covered by the guards 51 in a case in which the pallet 3 is placed on the conveyor 50 provided with the guards 51 to prevent the pallet 3 from falling off.

The present disclosure is not limited to the above-described embodiment. For example, in the above embodiment, when the degree of matching between the detection point cloud data acquired by the laser sensor 12 and the selected reference point cloud data is less than the threshold, the position and the state of the pallet 3 are estimated based on the pieces of the detection point cloud data acquired by the laser sensor 12, which match the reference point cloud data, but the present disclosure is not limited thereto. For example, the position and the state of the pallet 3 may be estimated by directly using the detection point cloud data acquired by the laser sensor 12.

In the above embodiment, the estimation values of the position and the state of the pallet 3 are evaluated by determining whether the degree of matching between the detection point cloud data acquired by the laser sensor 12 and the selected reference point cloud data is equal to or greater than the threshold determined in advance, but the present disclosure is not limited thereto. For example, the estimation values of the position and the state of the pallet 3 may be evaluated by using the variation (variance) in matching between the detection point cloud data and the reference point cloud data.

In the above embodiment, the position and the state of the pallet 3 are recognized when the pallet 3 is to be unloaded by the forklift truck 2, but the present disclosure is also applicable to a case where the position and the state of the pallet 3 are recognized in work environments other than cargo handling by the forklift truck 2.

What is claimed is:

1. A pallet recognition device that recognizes a position and a state of a pallet, the pallet recognition device comprising:
a memory configured to store pieces of reference data acquired in advance, the pieces of reference data corresponding to a plurality of types of pallets;
a detection unit configured to determine a type of the pallet;
a selection unit configured to select reference data corresponding to the type of the pallet detected by the detection unit from the pieces of reference data of the plurality of types of pallets stored in the memory;
a data acquisition unit configured to acquire detection data of the pallet; and
a matching processor configured to calculate estimation values of a position and a state of the pallet by matching the detection data acquired by the data acquisition unit and the reference data selected by the selection unit.

2. The pallet recognition device according to claim 1, further comprising:
an evaluation unit configured to evaluate the estimation values of the position and the state of the pallet calculated by the matching processor; and
a position-state determination unit configured to determine the position and the state of the pallet based on a result of evaluation by the evaluation unit.

3. The pallet recognition device according to claim 2, wherein
the matching processor calculates the estimation values of the position and the state of the pallet by matching the detection data and the reference data, and calculates a degree of matching between the detection data and the reference data, and
the evaluation unit evaluates the estimation values of the position and the state of the pallet by determining whether the degree of matching between the detection data and the reference data is equal to or greater than a threshold determined in advance.

4. The pallet recognition device according to claim 3, wherein the position-state determination unit determines the estimation values of the position and the state of the pallet calculated by the matching processor as the position and the state of the pallet when the evaluation unit determines that the degree of matching between the detection data and the reference data is equal to or greater than the threshold, and estimates the position and the state of the pallet based on the detection data acquired by the data acquisition unit when the evaluation unit determines that the degree of matching between the detection data and the reference data is less than the threshold.

5. The pallet recognition device according to claim 4, wherein the position-state determination unit extracts pieces of the detection data matching the reference data from the detection data acquired by the data acquisition unit, and estimates the position and the state of the pallet based on the pieces of detection data matching the reference data when it is determined that the degree of matching between the detection data and the reference data is less than the threshold.

6. The pallet recognition device according to claim 1, wherein
the detection unit has a camera that captures an image of the pallet, and determines the type of the pallet based on image data from the camera, the data acquisition unit irradiates the pallet with a laser and receives reflected light of the laser to detect a distance to the pallet and acquire detection point cloud data, and
the memory stores pieces of reference point cloud data corresponding to the plurality of types of the pallets.

7. The pallet recognition device according to claim 1, wherein one of the pieces of the reference data of the plurality of types of pallets is reference data for a state in which the pallet is partially covered by another object.
